(19) United States
(12) Patent Application Publication
(10) Pub. No.: US 2026/0322190 A1
(43) Pub. Date: Oct. 15, 2026

(54) STATOR FOR AN ELECTRIC MACHINE, ELECTRIC MACHINE, AND MANUFACTURING METHOD FOR MANUFACTURING A STATOR

(71) Applicant: AUDI AG, Ingolstadt (DE)

(72) Inventors: Philipp UHLMANN, Ingolstadt (DE); Korbinian WEBER, Ingolstadt (DE)

(21) Appl. No.: 19/462,859

(22) Filed: Jan. 28, 2026

(30) Foreign Application Priority Data
Jan. 29, 2025 (DE) 102025103097.9

(51) Int. Cl. H02K 1/18; H02K 15/028

(52) U.S. Cl. CPC H02K 1/185; H02K 15/028

(57) ABSTRACT

A stator for an electric machine is provided and includes a stator core body with at least two receptacles that pass completely through the stator core body in the axial direction, and a respective pin, which is received in the respective receptacle in such a way that a respective end pin section projects beyond the stator core body at both ends of the stator core body in the axial direction, wherein the respective end pin section is at least partially received in a respective blind hole of a housing of the stator that at least partially encloses the stator core body, so that the stator core body is suspended in the housing via the pins.

### BACKGROUND

### Technical Field

The disclosure relates to a stator for an electric machine comprising a stator core body with at least two receptacles that pass completely through the stator core body in the axial direction and a respective pin, which is received in the respective receptacle in such a way that a respective end pin section projects beyond the stator core body at both ends of the stator core body in the axial direction.

### Description of the Related Art

Typically, a transverse interference fit is used to attach the stator core body to a housing. For this purpose, the housing is heated in order to widen an opening in the housing that accommodates the stator due to thermal expansion. The stator is then inserted into the housing. Upon cooling, the transverse interference fit is established, and the stator is fixed in the housing.

However, this concept has several disadvantages. During assembly, the entire housing must be heated, which can be time-consuming and costly, especially with complex housing geometries, since in such cases the housing typically has to be heated via a furnace section. Furthermore, high compressive stresses occur in the laminated core when closing the bond, which can increase iron losses and thus reduce the efficiency of the electric machine. In addition, chips may be detrimentally lifted off the housing during such assembly. Even if the joining process has been designed as force-free joining, tolerances in the components and the manufacturing systems can repeatedly lead to damage to the housing by the typically sharp-edged laminated core, which in turn leads to high reject rates.

Publication US 2016 / 026 88 52 A1 describes a stator comprising a stator core body and two housing parts. The housing parts are pressed axially against the stator core body and clamp the latter between the housing parts by way of rods that pass through the stator core body and two screws that engage in the rod and pass through a through-hole in the respective housing part, and whose screw heads contact an outer surface of the housing part.

### BRIEF SUMMARY

The disclosure is based on the task of specifying a stator in which a stator core body can be connected to the housing substantially free of mechanical stresses, so that the above-mentioned disadvantages can be avoided.

In the case of a stator of the type mentioned at the beginning, it is provided according to the disclosure that the respective end pin section is accommodated, at least partially, in a respective blind hole of a housing of the stator that at least partially encloses the stator core body, so that the stator core body is suspended in the housing via the pins.

A stator core body of the above type offers the advantage that the laminated core remains substantially free of mechanical stresses in the electrically relevant region and thus, as explained above, a higher efficiency of the electric machine can be achieved. Even if axial forces act on the pins due to an abutment of the ends of the respective pins against the axial ends of the blind holes receiving the respective pins, these forces can be at least largely compensated by elastic deformation of the respective pins and thus do not lead to stressing of the stator core body or its laminated core. Radial and/or circumferential tolerances can also be largely compensated for by the pins.

The suspension of the stator core body via the pins in accordance with the disclosure also enables the axial and radial outer surfaces of the stator core body to be spaced apart from the housing. This decouples the stator core body from the housing, which has an advantageous acoustic effect.

In addition, the design according to the disclosure enables a simple assembly process during manufacturing, in which the risk of chip formation or damage to the housing can be eliminated or at least significantly reduced. In addition, almost any housing geometry is possible, so that, for example, integral housings, which may comprise a cooling jacket for the stator, can also be used.

The respective blind holes expediently have substantially the same, or only slightly larger, diameter than the pins, so that simple and advantageous force-free joining of the stator core body and the housing can be ensured. Accordingly, the diameter of the blind hole can correspond, in particular, to 1 to 1.5 times the diameter of the pin. Advantageously, all blind holes, and therefore also all pins, can have the same diameter.

The blind holes are located on an inner surface of the housing facing the stator core body, i.e., on the inside of the housing, and are, in particular, completely closed at an axial end of the housing, i.e., on the outside of the housing. Accordingly, the housing does not have any openings through which the axial end faces of the pins would be visible from the outside of the housing.

When the stator is mounted, i.e., after the stator core body has been suspended in the housing, the stator core body can advantageously be spaced, at least slightly, from the inner surface of the housing. In particular, the end pin sections are only partially accommodated in the respective blind holes, so that a respective section of the pin located outside the blind hole and the stator core body receptacle can act as a spacer that distances the stator core body from the inner wall of the housing having the blind hole.

Alternatively, however, it would also be possible for an outer surface of the stator core body to rest completely or partially against the inside of the housing, wherein the respective end pin sections can, in particular, be completely accommodated by the respective blind holes. It may be expedient for at least half of the end pin sections to be accommodated by the blind holes in order to ensure secure and resilient suspension of the stator core body in the housing.

In particular, the stator core body can be suspended exclusively by a form-fit and/or material bond between the respective end pin sections and the blind holes in the housing.

The pins can advantageously be designed threadless and/or be made of steel. The stator core body can comprise a laminated core, which, in particular, supports windings of the stator core body and which is formed, in particular, from steel laminations bonded together.

The receptacles of the stator core body extend, in particular, in the axial direction of the stator core body or of the stator and thus, in particular, substantially parallel to an axis of rotation of an electric machine comprising the stator. In particular, the direction of extension of the respective receptacle in the assembled state of such an electric machine can deviate by less than 10° or less than 5° from the direction in which the axis of rotation extends.

In an expedient further development of the disclosure, the respective pin can be connected to the respective receptacle in a force-fitting manner by way of a thermal hot-joining process.

When the stator core body is heated, the material thermally expands, and the diameter of the receptacles temporarily enlarges. When heated, the pins can therefore be inserted into the receptacles with little or no force. After cooling, a shrink-fit effect occurs, whereby the pins are anchored in the receptacles in a force-fitting manner. This offers the advantage that the stator core body is robustly held in the axial direction in a force-fitting manner. If the same holding force were to be achieved by axial press-fitting without thermal expansion of the receptacles, this would lead to high joining forces and thus to a high degree of tension in the laminated core of the stator core body.

The use of the thermal hot-joining process can be recognized in the finished stator, for example, by the fact that the resulting lattice structure of the material of the stator core body and of the respective pin at the interface between the stator core body and the pin is different from the lattice structure that would result from cold joining of the pins, for example, if the pins had been pressed into the corresponding receptacle of the cold stator core body with high force, due to the significantly different magnitude and direction of joining forces.

Conveniently, the respective receptacle can pass through a respective projection of a radial outer wall of the stator core body, wherein the projection extends over at least 50% of the length of the stator core body in the axial direction.

The stator core body or its laminated core, or the individual laminations, can have the projections, which in turn have an opening for receiving the pins. During the assembly, the individual laminated disks can be assembled in such a way that the projections are arranged in a row in the axial direction, resulting in a continuous receptacle for the corresponding pins being formed. In this case, the receptacles can surround the central pin section. It is expedient for the projection to be sufficiently large, so that the receptacle does not pass through the substantially annular base surface of the respective lamination, but is arranged radially completely outside the radius of the outer wall of the laminations or of the laminated core. Insofar as forces are transmitted to the pin to the wall of the recess, these lead at most to stresses in the laminated core in the region of the respective projection, so that stresses in the electromagnetically active yoke region of the laminated core and associated efficiency losses can be minimized by arranging the recesses in projections.

Advantageously, the stator core body can be impregnated with resin, which is thermally cured.

Among other things, this can serve to electrically insulate the windings of the stator core body and/or to reduce noise and vibrations. While the resin is curing under heating, the joining process can be realized between the pin and the receptacle, as already explained, whereby, in an advantageous way, no additional heating step is required to insert the pins into the receptacles.

According to the disclosure, the housing can have a first housing part with a recess that at least partially receives the stator core body, and a second housing part connected to the first housing part, wherein the first housing part forms those blind holes of the housing that at least partially receive the end pin sections projecting beyond the stator core body in the axial direction at a first axial end of the stator core body, and wherein the second housing part forms those blind holes of the housing that at least partially receive the end pin sections projecting beyond the stator core body in the axial direction at a second axial end of the stator core body opposite the first axial end.

Once the respective end pin sections have been received through the blind holes of the respective housing parts, both housing parts can be connected, for example, screwed together, in order to form the complete housing and thus also the stator according to the disclosure.

Furthermore, the disclosure relates to an electric machine with a rotor, wherein the electric machine comprises a stator according to the disclosure. The electric machine can be used in motor vehicles, for example, especially as a drive motor.

Moreover, the disclosure relates to a manufacturing method for manufacturing a stator for an electric machine, comprising:
provision of a stator core body with at least two receptacles that pass completely through the stator core body in the axial direction;
inserting a respective pin into the respective receptacle so that a respective end pin section projects beyond the stator core body in the axial direction at both ends of the stator core body; and
providing a first and a second housing part, wherein each housing part has blind holes, wherein the end pin sections at a first axial end of the stator core body are each inserted into one of the blind holes of the first housing part, and wherein the end pin sections at a second axial end of the stator core body opposite the first axial end are inserted into the blind holes of the second housing part when the first and second housing parts are assembled to form a housing of the stator, so that, in the assembled state, the stator core body is suspended in the housing via the pins and the blind holes.

First, the stator core body, which expediently comprises a laminated core or a winding carrier in general, is provided, wherein the pins are inserted into the corresponding receptacles of the stator core body in such a way that a central pin section is arranged within the receptacle and a respective end pin section of each pin projects beyond the stator core body at each axial end of the stator core body. For manufacturing reasons, it may be expedient to apply windings of the stator body to the winding carrier before inserting the pins, or to start the method with an already wound winding carrier or laminated core as the stator core body. Alternatively, winding of the winding carrier can also be wound after the pins have been inserted.

Subsequently, a first and a second housing part are then provided, each of which has blind holes congruent with the end pin sections, into which the pins are inserted, so that the stator core body is suspended in the housing in the final assembled state.

The manufacturing process for the stator according to the disclosure can also be used as part of a manufacturing process of the electric machine according to the disclosure, which, as already mentioned, comprises the stator according to the disclosure. Depending on the specific design of the housing, it may be advisable to install the rotor before the first and second housing parts are joined together. For example, the rotor can be inserted into the stator core body after the stator core body has been inserted into a recess in the first housing part. A rotor shaft of the rotor can, for example, be supported by a bearing of the first housing part and/or be guided through an opening in the first housing part. The second housing part can also have a bearing and/or an opening for the rotor shaft, which accommodates the rotor shaft when the housing parts are joined together. Alternatively, however, the housing can also have a sufficiently large opening to allow the rotor to be inserted after the housing is closed.

In a further development of the manufacturing method according to the disclosure, the respective pin can be connected to the respective receptacle in a force-fitting manner by way of a thermal hot-joining process, wherein the stator core body is heated before the respective pin is inserted into the respective receptacle, whereby a force-fit connection is formed and/or reinforced between the respective pin and the respective receptacle when the stator core body cools.

As already explained, the heating causes the material to expand thermally and thus also increases the diameter of the receptacles. Accordingly, the pins can be inserted into the receptacles with little or no force, and a robust force-fit can still be achieved after cooling.

Expediently, before heating the stator core body, it can be at least partially impregnated with resin, which hardens when the stator core body is heated.

In particular, windings previously applied to a winding carrier of the stator core body can be encapsulated and thus insulated and/or mechanically stabilized. As already explained above, the joining process between the pins and the receptacles of the stator core body can also be realized in this step, so that both the hardening of the resin and the expansion of the receptacles for inserting the pins are achieved by a single heating process. The receptacles can be covered while the resin is being applied, so that no resin can get into the receptacles.

Advantageously, the respective end pin section and the housing part forming the respective blind hole can have substantially the same temperature when the respective end pin section and the respective blind hole are connected.

This offers the advantage of a simple and fast joining process between the stator core body and the housing or the corresponding housing part, which can be realized without a further heating step.

The temperature can substantially correspond to the ambient temperature, wherein a temperature difference between the pin and the housing can be, in particular, between 0°C and 50°C.

All features disclosed for the stator according to the disclosure and the electric machine according to the disclosure can also be transferred, along with the advantages mentioned, to the manufacturing method according to the disclosure, and vice versa.

### BRIEF DESCRIPTION OF THE SEVERAL VIEWS OF THE DRAWINGS

Further advantages and details of the present disclosures can be seen from the exemplary embodiments described in the following as well as from the figures. The figures show schematically:

FIG. 1 is a schematic representation of a stator core body with pins held in receptacles of the stator core body;

FIG. 2 is a sectional view of an exemplary embodiment of the electric machine according to the disclosure, which comprises an exemplary embodiment of the stator according to the disclosure; and

FIG. 3 is a flow chart of an exemplary embodiment of the manufacturing method according to the disclosure for manufacturing a stator.

### DETAILED DESCRIPTION

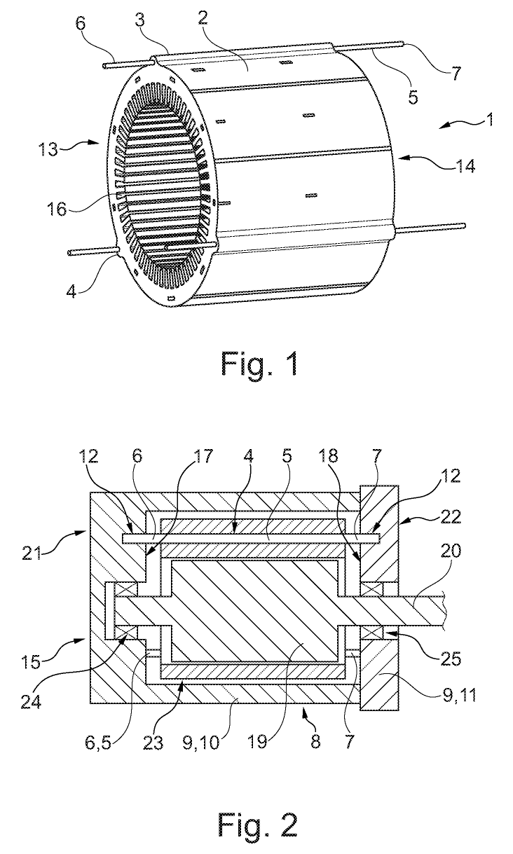

FIG. 1 schematically shows a stator core body 1, which, as will be explained later with reference to FIG. 2, is to be suspended in a housing 9 via several pins 5. To hold the pins 5 on the stator core body 1, three projections 3 are arranged on the outer wall 2 of the stator core body 1 in the example, each of which is penetrated by a receptacle 4. A respective pin 5 is arranged within each of these receptacles 4, wherein a central pin section is completely surrounded by the respective receptacle 4.

Two end pin sections 6, 7 of each pin 5 project beyond the stator core body 1 in the axial direction. As a result, the pin section 6 projects beyond a first axial end 13 of the stator core body 1 and the pin sections 7 project beyond a second axial end 14 of the stator core body 1. These pin sections 6, 7 allow the stator core body 1 to be suspended in the housing 9. The pins 5 have a uniform diameter throughout and therefore do not taper or widen.

For reasons of clarity, only the winding carrier of the stator core body 1 is shown in the example, which in the example is formed by a laminated core consisting of several individual laminations. The stator windings accommodated in the slots 16 and their winding heads are not shown. Such a stator core body 1 is typically impregnated with resin to insulate and mechanically stabilize these windings, which is also not shown.

In the example, the projections 3 and thus also the receptacles 4 extend in the axial direction over the entire length of the stator core body 1. Alternatively, the projections 3 could also extend over less than 100% of the length of the stator core body 1, wherein the projections 3 and the receptacles 4 advantageously may extend over at least 50% of the length of the stator core body 1.

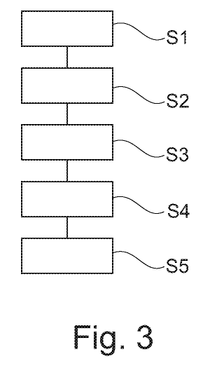

In the example, the pins 5 are connected to the receptacles 4 in a force-fitting manner using a thermal hot-joining process. This will be explained in more detail later with reference to FIG. 3. Alternatively or additionally, these components could also be adhesively bonded, for example.

FIG. 2 schematically shows an electric machine 15, which has a stator 8, comprising the stator core body 1 already shown in FIG. 1 and a housing 9, in which the stator core body 1 is suspended via the end pin sections 6, 7. In the example, the rotor shaft 20 of the rotor 19 of the electric machine 15, which is shown only schematically, is mounted on the housing 9 of the stator 8 and is guided through an opening in the second housing part 11 of the housing 9.

In the example, housing 9 has a first housing part 10 and a second housing part 11. Three blind holes 12 are arranged in each case on a respective inner surface 17, 18 of the first or second housing parts 10, 11 facing the stator core body 1, wherein only one of the blind holes 12 of the respective housing part 10, 11 is visible due to the cross-section shown in FIG. 2. Another blind hole of the respective inner surface 17, 18 is arranged in each case in front of and behind the sectional plane in FIG. 2.

The end pin sections 6, 7 of the pin 5 shown in FIG. 2, located in the image plane and in the upper image section, are form-fitted in the two blind holes 12 lying in the image plane. Only those parts of the end pin sections 6, 7 that project beyond the respective blind hole can be seen of the pin 5 located behind the image plane in the lower image region. The third of the pins 5 lies in front of the image plane and is therefore not shown.

As can be clearly seen in FIG. 2, the blind holes 12 are formed in such a way that they are closed towards the axial ends of the first and second housing parts 10, 11 and thus on the outer surfaces 21, 22 of the housing 9, so that the blind holes 12 do not completely penetrate the respective wall of the housing 9. In the present exemplary embodiment, the blind holes 12 have the same diameter as the pins 5, but can optionally also have a slightly larger diameter than the pins 5. The end pin sections 6, 7 are arranged in the corresponding blind holes 12 of the first or second housing part 10, 11 and, in the example, are connected to these exclusively in a form-fitting manner.

As can be seen in FIG. 2, the stator core body 1 is arranged at a distance from the first and second housing parts 10, 11 in the assembled state, i.e., after suspension within the housing 9. Accordingly, the blind holes 12 only partially accommodate the corresponding end pin sections 6, 7. Alternatively, the blind holes 12 can also completely accommodate the end pin sections 6, 7, so that the stator core body 1 is connected to the first and second housing parts 10, 11 without any gaps.

Due to the partially form-fitting reception of the end pin sections 6, 7, the stator core body 1 in the example is suspended in the housing 9 in such a way that it is coupled to the housing exclusively via the pins 5. Such partial decoupling of housing 9 and stator core body 1 can be useful for acoustic reasons.

FIG. 3 shows a schematic flow chart of a manufacturing method for manufacturing the stator 8 shown in FIG. 2.

In step S1, the stator core body 1 shown in FIG. 1 is provided, wherein the pins 5 are not yet arranged in the receptacles 4.

In step S2, the stator core body 1 or its windings are impregnated with resin, and then the stator core body 1 is heated in order to harden the resin.

In step S3, while the stator core body 1 is still heated and the receptacles 4 therefore have a larger diameter than in the original state due to thermal expansion of the material, the pins 5 are inserted into the respective receptacles 4 in such a way that two end pin sections 6, 7 project beyond the stator core body 1 in the axial direction. During the cooling process, the expansion of the receptacles 4 decreases until they reach their original diameter again, which results in a force-fit connection between the receptacles 4 and the pins 5. This results in the state shown in FIG. 1.

In step S4, the stator core body 1 with the pins 5 held on it is then inserted axially into the recess 23 of the first housing part 10 in such a way that the end pin sections 6 of the pins 5 facing the inner surface 17 engage in the blind holes 12 of the inner surface 17.

If the electric machine 15 shown in FIG. 2 is to be manufactured, the rotor 19 can then be inserted into the stator core body 1 in such a way that the section of the rotor shaft 20 on the left in FIG. 2 engages in the bearing 24 of the first housing part 10, as shown in FIG. 2.

In step S5, the second housing part 11 is then placed on the first housing part 10 in such a way that the end pin sections 7 are inserted into the blind holes 12 of the second housing part 11. If the rotor 19 is already installed, the rotor shaft 20 can be guided through the opening 25 of the second housing part 11.

After connecting the housing parts 10, 11 to form the housing 9, for example, by screwing them together, the stator core body 1 is thus suspended in the housing 9 in the final assembled state via the pins 5 and, in the example, specifically via the form-fitting reception of the end pin sections 6, 7 in the respective blind holes 12 of the housing 9.

During the respective joining process between the end pin sections 6, 7 and the respective blind hole 12 in steps S4 and S5, the end pin sections 6, 7, and the first and second housing parts 10, 11 in the present example have at least approximately the same temperature, which corresponds to the ambient temperature.

German patent application no. 102025103097.9, filed Jan. 29, 2025, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A stator for an electric machine, comprising:
a stator core body with at least two receptacles that pass completely through the stator core body in an axial direction; and
a respective pin, which is received in a respective receptacle of the at least two receptacles in such a way that a respective end pin section projects beyond the stator core body at both ends of the stator core body in the axial direction,
wherein the respective end pin section is at least partially accommodated in a respective blind hole of a housing of the stator at least partially enclosing the stator core body, so that the stator core body is suspended in the housing via the pins.

2. The stator according to claim 1, wherein the respective pin is connected to the respective receptacle in a force-fitting manner by way of a thermal hot-joining process.

3. The stator according to claim 1, wherein
the respective receptacle passes through a respective projection of a radial outer wall of the stator core body, which projection extends over at least 50% of a length of the stator core body in the axial direction.

4. The stator according to claim 1, wherein
the stator core body is impregnated with resin, which is thermally cured.

5. The stator according to claim 1, wherein
the housing has a first housing part with a recess at least partially receiving the stator core body that forms blind holes of the housing that at least partially receive the end pin sections projecting in the axial direction beyond the stator core body at a first of the axial ends of the stator core body,
and a second housing part connected to the first housing part that forms blind holes of the housing that at least partially receive the end pin sections projecting beyond the stator core body in the axial direction at a second axial end of the stator core body opposite the first axial end.

6. An electric machine with a rotor and a stator according to claim 1.

7. A manufacturing method for manufacturing a stator for an electric machine, comprising:
providing a stator core body with at least two receptacles that pass completely through the stator core body in the axial direction;
inserting a respective pin into a respective receptacle of the at least two receptacles, so that a respective end pin section at both ends of the stator core body projects beyond the stator core body in the axial direction; and
providing a first and a second housing part, each housing part having blind holes, wherein the end pin sections at a first axial end of the stator core body are inserted into respective blind holes of the first housing part in each case, wherein the end pin sections at a second axial end of the stator core body opposite the first axial end are inserted into the blind holes of the first housing part, and wherein the end pin sections at a second axial end of the stator core body opposite the first axial end are introduced into the blind holes of the second housing part when the first and second housing parts are joined together to form a housing of the stator, so that, in the assembled state, the stator core body is suspended in the housing via the pins and the blind holes.

8. The manufacturing method according to claim 7, wherein
the respective pin is connected to the respective receptacle in a force-fitting manner by way of a thermal hot-joining process, wherein the stator core body is heated before the respective pin is inserted into the respective receptacle, whereby, upon cooling of the stator core body, a force-fit connection is formed and/or reinforced between the respective pin and the respective receptacle.

9. The manufacturing method according to claim 8, wherein
before the stator core body is heated, it is at least partially impregnated with resin, which hardens when the stator core body is heated.

10. The manufacturing method according to claim 7, wherein
the respective end pin section and the housing part forming the respective blind hole have substantially the same temperature when the respective end pin section and the respective blind hole are connected.
